(19) United States
(12) Patent Application Publication
(10) Pub. No.: US 2010/0240426 A1
(43) Pub. Date: Sep. 23, 2010

(54) SLIDING PORTABLE TELEPHONE

(75) Inventors: Junji Tanaka, Daito-shi (JP); Minoru Taneda, Moriguchi-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Fushimi-ku, Kyoto (JP)

(21) Appl. No.: 12/677,509

(22) PCT Filed: Sep. 4, 2008
(86) PCT No.: PCT/JP2008/065946

§ 371 Date: Jun. 4, 2010

(30) Foreign Application Priority Data
Sep. 10, 2007 (JP) 2007-234406

(51) Int. Cl. H04W 88/02

(52) U.S. Cl. 455/575.4

(57) ABSTRACT

In the sliding portable telephone of the present invention, on the surface of the base housing, a photoconductive member is placed along a boundary line between a first surface region which is exposed when the slide housing is placed at the open position and a second surface region which is covered by the slide housing, a light emitting element for emitting light toward an end part of the photoconductive member on the second surface region side is arranged inside the base housing. The slide housing is provided with a reflecting plate reflecting light which has passed through the photoconductive member toward an end part of the photoconductive member on the first surface region side at a position opposed to a surface of the photoconductive member when the slide housing is placed at the open position.

### TECHNICAL FIELD

The present invention relates to a sliding portable telephone comprising a base housing and a slide housing engaging each other slidably.

### BACKGROUND ART

As shown in FIG. 9, a sliding portable telephone comprises a base housing 8 provided with a plurality of operation keys 81 arranged on a surface thereof and a slide housing 9 provided with a display 91 and a plurality of operation keys 94 arranged on a surface thereof. The slide housing 9 can be reciprocated between a close position where the slide housing 9 covers the plurality of operation keys 81 of the base housing 8 and an open position where the plurality of operation keys 81 of the base housing 8 are exposed.

In such a sliding portable telephone, illuminating a key operation surface where the plurality of operation keys 81 are arranged in a state where the slide housing 9 is placed at the open position, as shown in FIG. 9, provides a good operability particularly during nighttime.

Also, in the sliding portable telephone shown in FIG. 9, there has been employed a configuration (e.g., Japan Patent Laid-Open 2006-129168) which improves visibility of the operation keys 81 by providing an illuminator 92 for lighting up the key operation surface of the base housing 8 on an end face 93 of the slide housing 9 which stands up from the surface of the base housing 8 in a state where the slide housing 9 is placed at the open position.

In the sliding portable telephone, in the state where the base housing 8 is placed at the open position, a step is formed between the surface of the base housing 8 and the surface of the slide housing 9. The key operation surface is located on the surface of the base housing 8, namely a lower side of the step, and therefore, a tip of a finger might hit the end face 93 of the slide housing 9 at the time of operating the operation keys 81. Therefore, a user's recognition of a terminal position of the key operation surface of the base housing 8 influences the operability.

According to the sliding portable telephone shown in FIG. 9, the illuminator 92 is arranged on the end face 93 of the slide housing 9, and the terminal position of the key operation surface of the base housing 8 can be clearly indicated to a user by the illuminator 92.

### DISCLOSURE OF THE INVENTION

### Problems to be Solved by the Invention

However, in the conventional sliding portable telephone shown in FIG. 9, employed is a configuration in which the illuminator 92 is arranged at an end part of the slide housing 9, and therefore, in the end part of the slide housing 9, it is necessary to secure a space for arranging the illuminator 92 as well as a space for arranging the plurality of operation keys 94. As a result, there has been a problem of increase in size of the slide housing 9.

An object of the present invention is to provide a sliding portable telephone comprising a base housing 2 and a slide housing 1, which can indicate clearly a terminal position of a key operation surface of the base housing 2 to a user, and furthermore, which does not increase the size thereof.

### Means for Solving the Problem

A sliding portable telephone according to the present invention has a slide construction comprising a first housing and a second housing. The first housing includes a numerical keypad which is covered by the second housing when slide is closed, the first housing further includes light emitting means configured to make vicinity of an end face of the second housing bright, a reflection part for reflecting light is provided on a surface of the second housing opposed to the light emitting means, and the light emitting means and the reflection part are arranged so as to make the vicinity of the end face of the second housing emit light.

Here, the light emitting means comprises a light emitting element and a photoconductive member, light from the light emitting element makes the vicinity of the end face bright through the photoconductive member. Alternatively, the light reflected on the reflection part in the first housing through the photoconductive member returns to the photoconductive member again, and is again reflected on a bottom face portion of the photoconductive member to make the vicinity of the end face bright.

Also, in a more particular configuration, the sliding portable telephone according to the present invention comprises the base housing 2 provided with a plurality of operation keys 21 arranged on a surface thereof and the slide housing 1 provided with a display 11 arranged on a surface thereof. The slide housing 1 can be reciprocated between a close position where the slide housing 1 covers the plurality of operation keys 21 of the base housing 2 and an open position where the plurality of operation keys 21 of the base housing 2 are exposed.

Here, on the surface of the base housing 2, a photoconductive member 3 is placed along a boundary line between a first surface region X which is exposed when the slide housing 1 is placed at the open position and a second surface region Y which remains covered by the slide housing 1 even when the slide housing 1 is placed at the open position. A light emitting element 4 for emitting light toward an end part of the photoconductive member 3 on the second surface region side is arranged inside the base housing 2.

In contrast, the slide housing 1 is provided with a reflecting plate 5 reflecting the light which has passed through the photoconductive member 3 toward an end part of the photoconductive member 3 on the first surface region side at a position opposed to the surface of the photoconductive member 3 when the slide housing 1 is placed at the open position.

In the sliding portable telephone according to the present invention described above, in a state where the slide housing 1 is placed at the open position, the light emitted from the light emitting element 4 enters the end part of the photoconductive member 3 on the second surface region side. A part of the light progresses in the photoconductive member 3 toward the end part of the photoconductive member 3 on the first surface region side, and thereafter, is outputted from a surface of the end part on the first surface region side to the key operation surface side of the base housing 2. Also, remaining light of the light which enters the photoconductive member 3 passes through the photoconductive member 3, and thereafter, is reflected by the reflecting plate 5 arranged in the slide housing 1, and returns to the end part of the photoconductive member 3 on the first surface region side. And then, the light is reflected again on a bottom face of the photoconductive member 3, and is outputted from the surface of the end part on the first surface region side to the key operation surface side of the base housing 2.

As a result, the end part of the photoconductive member 3 on the first surface region side emits light brightly, and the terminal position of the key operation surface of the base housing 2 is clearly indicated.

In a particular configuration, the end part of the photoconductive member 3 on the first surface region side is provided at a position where the end part protrudes from an end face 13 of the slide housing 1 when the slide housing 1 is placed at the open position, and is adjacent to the key operation surface of the base housing 2 which is provided with the plurality of operation keys 21 arranged thereon.

According to this particular configuration, since the end part of the photoconductive member 3 protrudes from the end face 13 of the slide housing 1, bright light emission of the end part clearly indicates the terminal position of the key operation surface with a sufficient illumination intensity.

In another particular configuration, a light reflection layer 6 is formed on a rear face of the end part of the photoconductive member 3 on the first surface region side.

According to this particular configuration, the light which is reflected by the reflecting plate 5 and returns to the end part of the photoconductive member 3 on the first surface region side is reflected by the light reflection layer 6 with higher reflectance on the bottom face of the photoconductive member 3. Therefore, the light outputted from the end part on the first surface region side toward the key operation surface side of the slide housing 1 has a sufficient quantity of light.

In a further particular configuration, the photoconductive member 3 has a form of a long board extending along a boundary line between the first surface region and the second surface region of the base housing 2.

According to this particular configuration, since the end part of the photoconductive member 3 on the first surface region side emits light brightly along the boundary line between the first surface region and the second surface region of the base housing 2, the terminal position of the key operation surface of the base housing 2 is clearly indicated as the boundary line.

### Effect of the Invention

According to the present invention, it is possible to reduce the size of the housing.

### BRIEF DESCRIPTION OF THE DRAWINGS

FIG. 1 is a perspective view showing the closed state of a sliding portable telephone according to the present invention;

FIG. 2 is a perspective view showing an open state of the sliding portable telephone;

FIG. 3 is a cross-sectional view along an A-A line in FIG. 2;

FIG. 4 is an exploded perspective view of a slide housing and a base housing;

FIG. 5 is an exploded perspective view of the slide housing and the base housing shown in a different direction from in FIG. 4;

FIG. 6 is an exploded perspective view of the base housing;

FIG. 7 is a cross-sectional view showing an essential part of the sliding portable telephone in the open state;

FIG. 8 is a view for explaining a proceeding path of light emitted from a light emitting element; and

FIG. 9 is a perspective view showing the open state of a conventional sliding portable telephone.

### EXPLANATION OF REFERENCE NUMERALS

1 slide housing

11 display

12 operation key

13 end face

2 base housing

21 operation key

3 photoconductive member

4 light emitting element

5 reflecting plate

6 light reflection layer

### BEST MODE FOR CARRYING OUT THE INVENTION

An embodiment of the present invention is to be described in detail below with reference to the drawings.

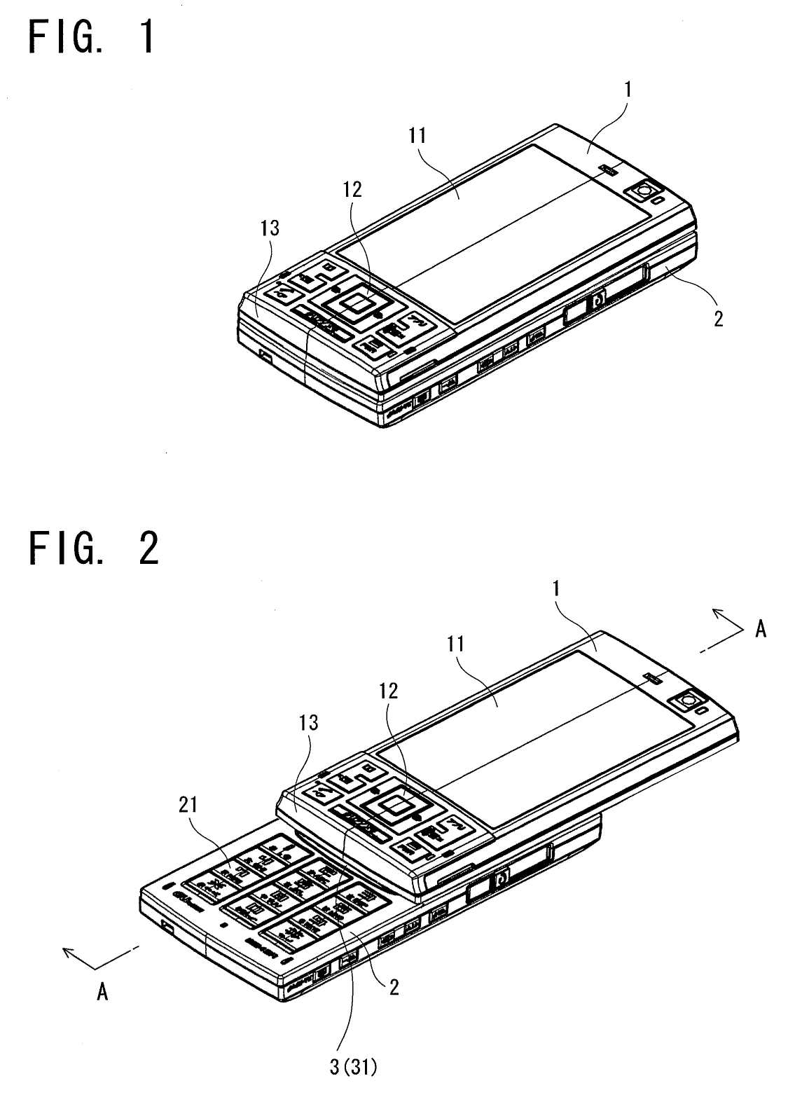

As shown in FIGS. 1 to 3, a sliding portable telephone according to the present invention comprises a base housing 2 provided with a plurality of operation keys 21 arranged on a surface thereof and a slide housing 1 provided with a display 11 and a plurality of operation keys 12 arranged on a surface thereof. The slide housing 1 engages the base housing 2 slidably.

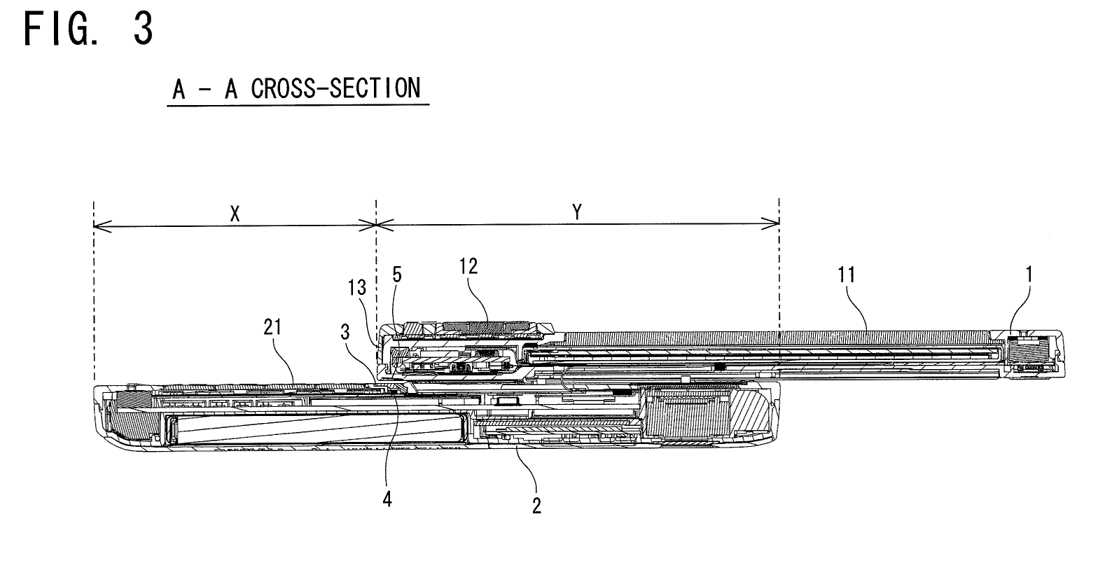

Therefore, the slide housing 1 can be reciprocated between a close position where the slide housing 1 covers the plurality of operation keys 21 of the base housing 2 as shown in FIG. 1 and an open position where the plurality of operation keys 21 of the base housing 2 are exposed as shown in FIGS. 2 and 3.

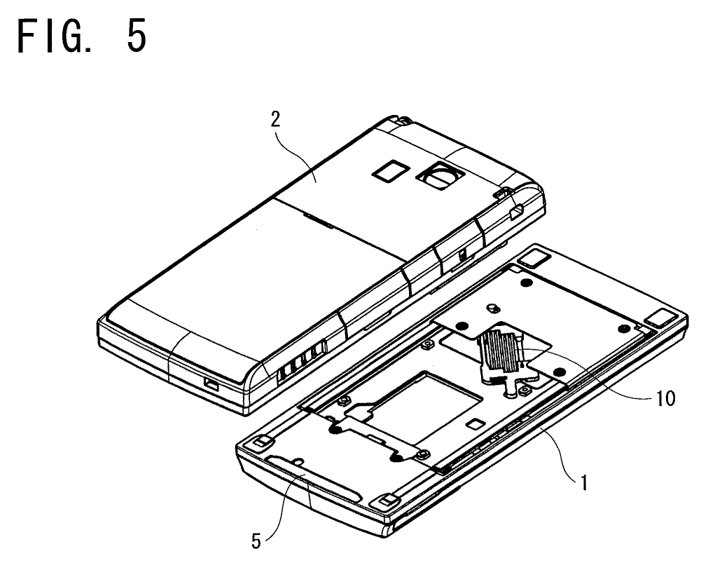

Also, an urging mechanism 10 intervenes between the base housing 2 and the slide housing 1 as shown in FIG. 5 to urge the slide housing 1 toward the close position and the open position.

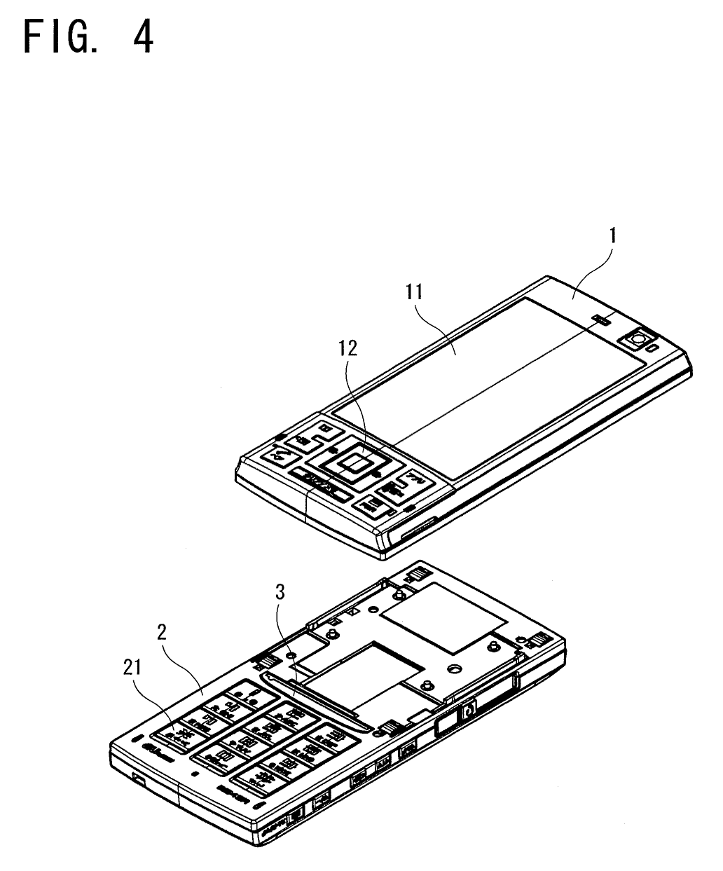

As shown in FIGS. 2 and 4, on the surface of the base housing 2, a laterally long board-like photoconductive member 3 is placed along a boundary line between a first surface region (area X shown in FIG. 3) which is exposed when the slide housing 1 is placed at the open position and a second surface region (area Y shown in FIG. 3) which remains covered by the slide housing 1 even when the slide housing 1 is placed at the open position.

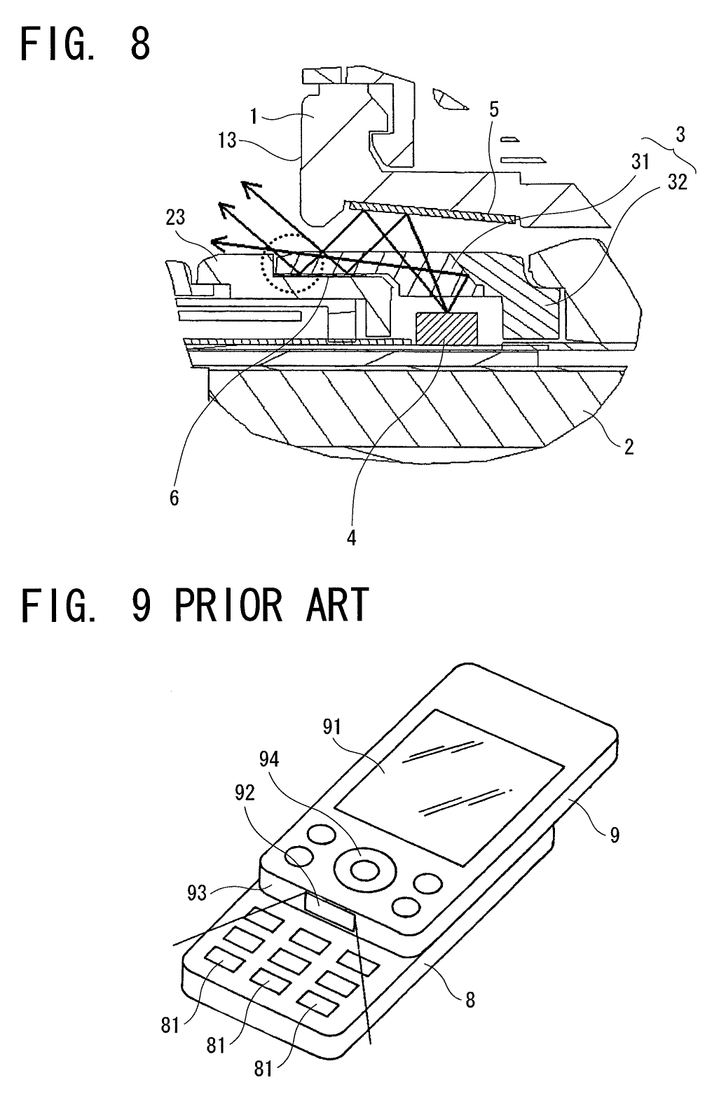

The photoconductive member 3 is a resin molded article comprising a light-transmitting part 31 and a non-light-transmitting part 32 as shown in FIG. 8, and leads light in the light-transmitting part 31. The light is reflected on a boundary surface between the light-transmitting part 31 and the non-light-transmitting part 32. In a state where the slide housing 1 is placed at the open position, an end part of the light-transmitting part 31 of the photoconductive member 3 protrudes slightly from the end face 13 of the slide housing 1 as shown in FIG. 2.

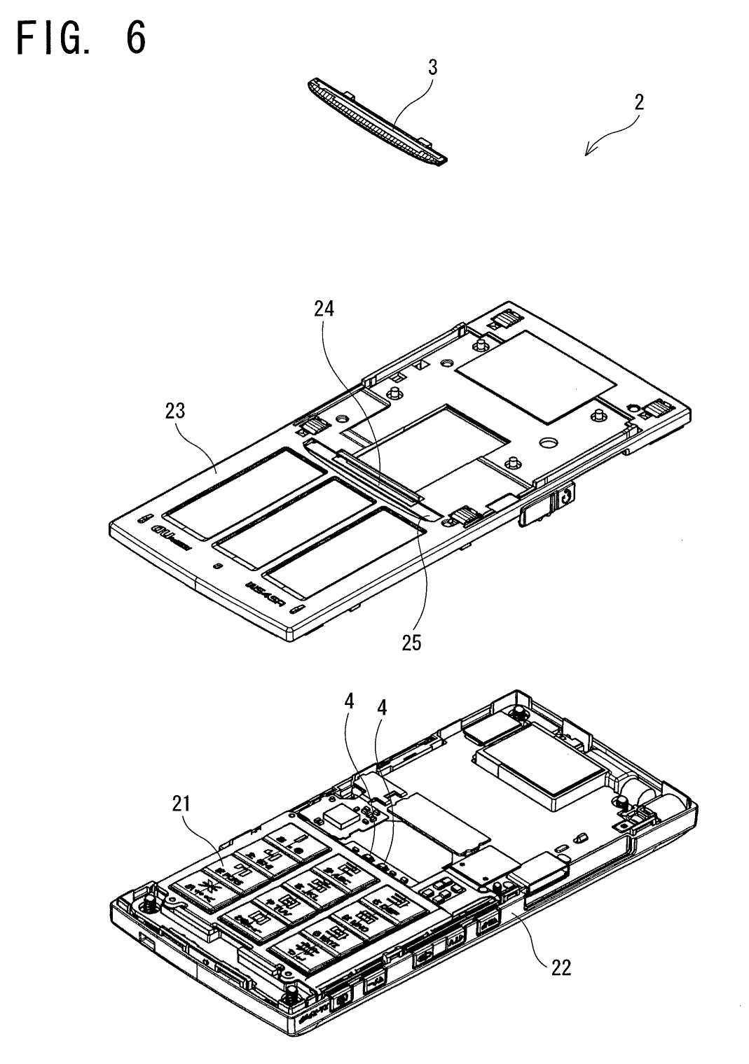

As shown in FIG. 6, the base housing 2 comprises a body 22 provided with the plurality of operation keys 21 arranged thereon and a cover 23 covering the body 22. In a central part of the cover 23, formed is a recess 25 in which the photoconductive member 3 fits, and a slit aperture 24 opens in a central part of the recess 25.

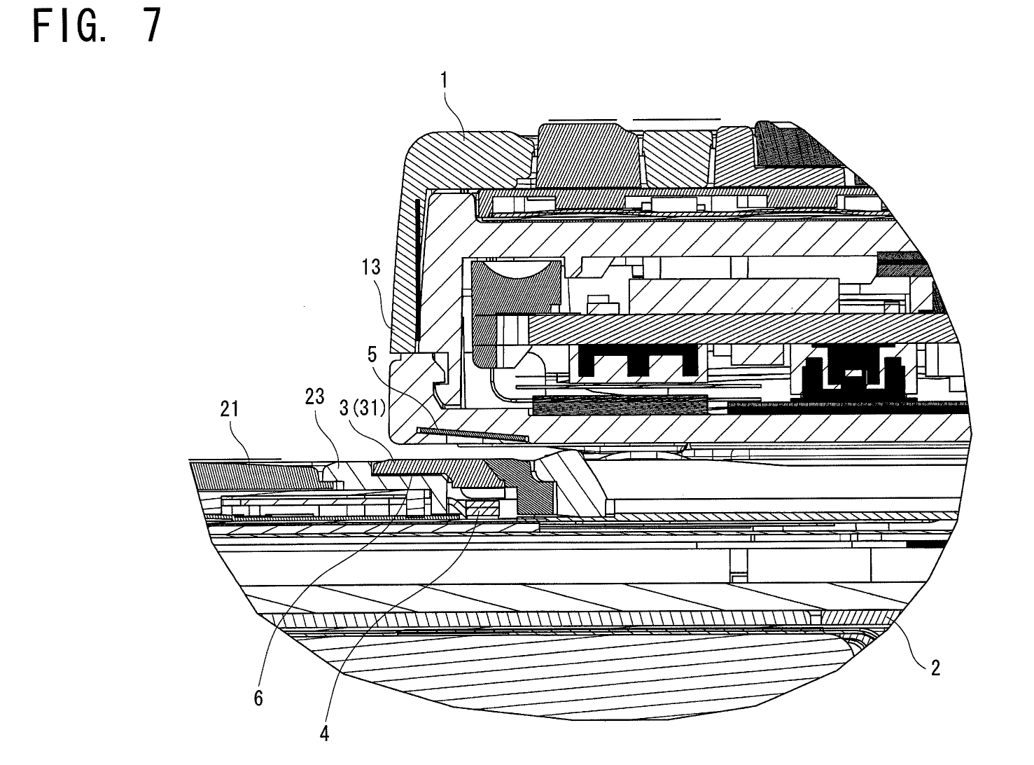

Also, in the body 22 of the base housing 2, a light emitting element 4 composed of an LED is arranged at a position opposed to the photoconductive member 3 placed on the cover 23. The light emitting element 4 is opposed to an end part of the light-transmitting part 31 of the photoconductive member 3 on the second surface region side as shown in FIG. 7.

In contrast, as shown in FIGS. 5 and 7, in the slide housing 1, arranged is a reflecting plate 5 with a posture having a slight elevation angle toward the first surface region of the base housing 2 at a position opposed to the surface of the photoconductive member 3 when the slide housing 1 is placed at the open position.

Also, as shown in FIG. 7, on the photoconductive member 3, a light reflection layer 6 is formed on a rear face of the end part of the base housing 2 on the first surface region side by aluminum deposition.

In the sliding portable telephone of the present invention described above, as shown in FIG. 8, in the state where the slide housing 1 is placed at the open position, the light emitted from the light emitting element 4 enters the end part of the light-transmitting part 31 of the photoconductive member 3 on the second surface region side. A part of the light progresses in the photoconductive member 3 toward the end part on the first surface region side, and thereafter, is outputted from the surface of the end part on the first surface region side toward the key operation surface side of the base housing 2. Also, remaining light of the light which enters the photoconductive member 3 passes through the photoconductive member 3, and thereafter, is reflected by the reflecting plate 5 arranged in the slide housing 1, and returns to the end part of the photoconductive member 3 on the first surface region side. And then, the light is reflected again on the bottom face of the photoconductive member 3, and is outputted from the surface of the end part on the first surface region side to the key operation surface side of the base housing 2.

Here, since the end part of the photoconductive member 3 on the first surface region side slightly protrudes from the end face 13 of the slide housing 1, the bright light emission of the end part clearly indicates a terminal position of the key operation surface of the base housing 2 with a sufficient illumination intensity.

In the sliding portable telephone of the present invention described above, the light emitting element 4 is arranged in the base housing 2, and only the reflecting plate 5 is placed in the slide housing 1. Therefore, an increase in size of the slide housing 1 is not caused.

Also, the light emitting element 4 is arranged at a position spaced sufficiently from a space where the operation keys 21 of the base housing 2 are arranged, the light emitted from the light emitting element 4 is led to the end part of the photoconductive member 3 on the first surface region side by the photoconductive member 3 and the reflecting plate 5. Therefore, reduction of thickness of the base housing 2 is attempted by employing such an arrangement of the light emitting element 4.

Further, in the sliding portable telephone of the present invention described above, it is possible to notify a user of an event such as incoming call, mail reception, alarm or the like by making a vicinity of the boundary of the housings emit light in a state where the slide housing and the base housing are open, even when, for example, an image or video is displayed, a Web screen is displayed, or an additional function such as game is executed on a large display. Therefore, it is possible to notify the user in a way easy to notice.

Moreover, at the time of notification of the event, the screen such as the displayed image or video can continue to be displayed, and therefore, the display is not disturbed by the event notification. In the case of the event notification by light emission of the vicinity of boundary, a displayed screen may be changed to a screen concerning the event notification.

As described above, with the sliding portable telephone according to this embodiment, by making the end part of the photoconductive member 3 emit light brightly, the terminal position of the key operation surface of the base housing 2 can be clearly indicated to the user. Here, the light emitting element 4 is arranged in the base housing 2, and only the reflecting plate 5 is placed in the slide housing 1. Therefore, an increase in size of the slide housing 1 is not caused. Also, even if the light emitting element 4 is arranged at a position spaced sufficiently from an area where the operation key 21 of the base housing 2 is arranged, the light emitted from the light emitting element 4 is led to the end part of the photoconductive member 3 on the first surface region side by the photoconductive member 3 and the reflecting plate 5. Therefore, it is possible to reduce the size of the base housing 2 by employing such an arrangement of the light emitting element 4.

The present invention is not limited to the foregoing embodiment in construction but can be modified variously within the technical range set forth in the appended claims. For example, instead of the posture of the reflecting plate 5 having the slight elevation angle, a light emission central line of the light emitting element 4 may be arranged in the posture having the slight elevation angle, and the reflecting plate 5 may be arranged generally parallel to a housing surface.

As a further embodiment, each of an angle of the reflecting plate 5 and an angle of the light emission central line of the light emitting element 4 may have an elevation angle.

1. A sliding portable telephone having a slide construction comprising a first housing and a second housing, wherein the first housing includes a numerical keypad which is covered by the second housing when slide is closed, the first housing further includes light emitting means configured to make vicinity of an end face of the second housing bright, a reflection part for reflecting light is provided on a surface of the second housing opposed to the light emitting means, and the light emitting means and the reflection part are arranged so as to make the vicinity of the end face of the second housing emit light.

2. The sliding portable telephone according to claim 1, wherein the light emitting means comprises a light emitting element and a photoconductive member, light from the light emitting element makes the vicinity of the end face bright through the photoconductive member, alternatively, the light reflected on the reflection part in the first housing through the photoconductive member returns to the photoconductive member again, and is again reflected on a bottom face portion of the photoconductive member to make the vicinity of the end face bright.

3. A sliding portable telephone comprising a base housing 2 provided with a plurality of operation keys 21 arranged on a surface thereof and a slide housing 1 provided with a display 11 arranged on a surface thereof, the base housing 2 and the slide housing 1 engaging each other slidably, the slide housing 1 being able to be reciprocated between a close position where the slide housing 1 covers the plurality of operation keys 21 of the base housing 2 and an open position where the plurality of operation keys 21 of the base housing 2 are exposed,
wherein on the surface of the base housing 2, a photoconductive member 3 is placed along a boundary line between a first surface region which is exposed when the slide housing 1 is placed at the open position and a second surface region which remains covered by the slide housing 1 even when the slide housing 1 is placed at the open position, a light emitting element 4 for emitting light toward an end part of the photoconductive member 3 on the second surface region side is arranged inside the base housing 2, and the slide housing 1 is provided with a reflecting plate 5 reflecting the light which has passed through the photoconductive member 3 toward an end part of the photoconductive member 3 on the first surface region side at a position opposed to a surface of the photoconductive member 3 when the slide housing 1 is placed at the open position.

4. The sliding portable telephone according to claim 3, wherein the end part of the photoconductive member 3 on the first surface region side is provided at a position where the end part protrudes from an end face 13 of the slide housing 1 when the slide housing 1 is placed at the open position, and is adjacent to a key operation surface of the base housing 2 which is provided with the plurality of operation keys 21 arranged thereon.

5. The sliding portable telephone according claim 3, wherein a light reflection layer 6 is formed on a rear face of the end part of the photoconductive member 3 on the first surface region side.

6. The sliding portable telephone according claim 3, wherein the photoconductive member 3 has a form of a long board extending along a boundary line between the first surface region and the second surface region of the base housing 2.
